(19) United States
(12) Patent Application Publication
(10) Pub. No.: US 2025/0106125 A1
(43) Pub. Date: Mar. 27, 2025

(54) ANALYSIS DEVICE, ANALYSIS METHOD, AND ANALYSIS PROGRAM

(71) Applicant: NIPPON TELEGRAPH AND TELEPHONE CORPORATION, Tokyo (JP)

(72) Inventors: Satomi INOUE, Tokyo (JP); Yuhei HAYASHI, Tokyo (JP); Masato YAMADA, Tokyo (JP); Chiharu MORIOKA, Tokyo (JP); Yuki MIYOSHI, Tokyo (JP); Akinori FURUTA, Tokyo (JP); Atsushi SUTO, Tokyo (JP)

(73) Assignee: NIPPON TELEGRAPH AND TELEPHONE CORPORATION, Tokyo (JP)

(21) Appl. No.: 18/729,877

(22) PCT Filed: Jan. 26, 2022
(86) PCT No.: PCT/JP2022/002963

§ 371 Date: Jul. 17, 2024

(51) Int. Cl. H04L 43/026; H04L 12/46; H04L 69/22

(52) U.S. Cl. CPC H04L 43/026; H04L 69/22; H04L 12/4641

(57) ABSTRACT

An analysis device (40) receives an xFlow packet that is generated based on a sampled encapsulation packet and includes information regarding an outer header of the encapsulation packet and statistical information of a flow including the encapsulation packet. The analysis device (40) collates information regarding the outer header associated with information for identifying a user of VPN with information regarding the outer header included in the xFlow packet received by a reception unit (431), and specifies the user of the VPN from which the xFlow packet is transferred.

### TECHNICAL FIELD

The present invention relates to an analysis device, an analysis method, and an analysis program.

### BACKGROUND ART

conventionally, xflow is known as a technique for network monitoring and traffic trend analysis.

xFlow is a method of totalizing and analyzing traffic by transferring statistical information calculated from header information of a sampled packet or a header portion itself (header sample) (see, for example, Non Patent Literature 1 (NetFlow), Non Patent Literatures 2 to 7 (IPFIX), and Non Patent Literatures 8 to 10 (sFlow, IPFIX w/IE315)).

In addition, conventionally, a packet encapsulation technique is known in which a packet is embedded in a payload of another packet on a network and the another packet is transferred.

In addition, for example, a format conversion technology that enables extraction and analysis of a packet inside a capsule (hereinafter, inner packet) in a RAW packet and a header sample is known (see, for example, Patent Literatures 1 to 3).

In addition, for example, there is known a technique for registering a header of an inner packet and a header of a packet outside a capsule (hereinafter, the outer packet) in a database in association with each other for an encapsulation packet (see, for example, Patent Literature 4).

### CITATION LIST

### Patent Literature

Patent Literature 1: JP 2019-097069 A

Patent Literature 2: JP 2021-090161 A

Patent Literature 3: WO 2021/149245 A

Patent Literature 4: JP 2020-174257 A

### Non Patent Literature

Non Patent Literature 1: “Cisco Systems NetFlow Services Export Version 9” (RFC 3954), [retrieved on Jan. 14, 2022], Internet <URL:https://www.rfc-editor.org/rfc/rfc3954.txt>

Non Patent Literature 2: “Bidirectional Flow Export Using IP Flow Information Export (IPFIX)” (RFC 5103), [retrieved on Jan. 14, 2022], Internet <URL:https://www.rfc-editor.org/rfc/rfc5103.txt>

Non Patent Literature 3: “Specification of the IP Flow Information Export (IPFIX) Protocol for the Exchange of Flow Information” (RFC 7011), [retrieved on Jan. 14, 2022 ], Internet <URL:https://www.rfc-editor.org/rfc/rfc7011.txt>

Non Patent Literature 4: “Information Model for IP Flow Information Export (IPFIX)” (RFC 7012), [retrieved on Jan. 14, 2022], Internet <URL:https://www.rfc-editor.org/rfc/rfc7012.txt>

Non Patent Literature 5: “Guidelines for Authors and Reviewers of IP Flow Information Export (IPFIX) Information Elements” (RFC 7013), [retrieved on Jan. 14, 2022], Internet <URL:https://www.rfc-editor.org/rfc/rfc7013.txt>

Non Patent Literature 6: “Flow Selection Techniques” (RFC 7014), [retrieved on Jan. 14, 2022], Internet <URL:https://www.rfc-editor.org/rfc/rfc7014.txt>

Non Patent Literature 7: “Flow Aggregation for the IP Flow Information Export (IPFIX) Protocol” (RFC 7015), [retrieved on Jan. 14, 2022], Internet <URL:https://www.rfc-editor.org/rfc/rfc7015.txt>

Non Patent Literature 8: “InMon Corporation's sFlow: A Method for Monitoring Traffic in Switched and Routed Networks” (RFC 3176), [retrieved on Jan. 14, 2022], Internet <URL:https://www.rfc-editor.org/rfc/rfc3176.txt>

Non Patent Literature 9: “Information Elements for Data Link Layer Traffic Measurement” (RFC 7133), [retrieved on Jan. 14, 2022], Internet <URL:https://www.rfc-editor.org/rfc/rfc7133.txt>

Non Patent Literature 10: “sFlow Version 5”, [retrieved on Jan. 14, 2022], Internet <URL:https://sflow.org/sflow version 5.txt>

### SUMMARY OF INVENTION

### Technical Problem

However, the conventional technology has a problem that it may be difficult to analyze traffic in units of virtual private network (VPN).

For example, the statistical information in the conventional xFlow is calculated in units of granularity of 5-tuple of the inner packet or a tunnel. Therefore, when each of a plurality of users uses the VPN, it is difficult to specify which user's VPN the flow corresponds to.

### Solution to Problem

In order to solve the above-described problems and achieve the object, an analysis device includes: a reception unit, configured to receive an xFlow packet generated based on a sampled encapsulation packet, the xFlow packet including information regarding an outer header of the encapsulation packet and statistical information of a flow including the encapsulation packet; and a collation unit configured to collate information regarding an outer header associated with information for identifying a user of a VPN and information regarding an outer header included in an xFlow packet received by the reception unit to specify the user of the VPN from which the xFlow packet is transferred.

### Advantageous Effects of Invention

According to the present invention, traffic can be analyzed in units of VPNs.

### BRIEF DESCRIPTION OF DRAWINGS

FIG. 1 is a diagram illustrating a configuration example of an analysis system according to a first embodiment.

FIG. 2 is a diagram illustrating a configuration example of a conversion device according to the first embodiment.

FIG. 3 is a diagram illustrating a configuration example of an analysis device according to the first embodiment.

FIG. 4 is a diagram illustrating an example of VPN information.

FIG. 5 is a diagram illustrating an example of flow statistical information.

FIG. 6 is a sequence diagram for explaining a flow of processing of the analysis system.

FIG. 7 is a view illustrating an example of an analysis result screen.

FIG. 8 is a flowchart illustrating a flow of processing of the analysis device.

FIG. 9 is a diagram illustrating an example of a computer that executes an analysis program.

### DESCRIPTION OF EMBODIMENTS

Hereinafter, embodiments of an analysis device, an analysis method, and an analysis program according to the present application will be described in detail with reference to the drawings. Note that the present invention is not limited to the embodiment described below.

### Configuration of First Embodiment

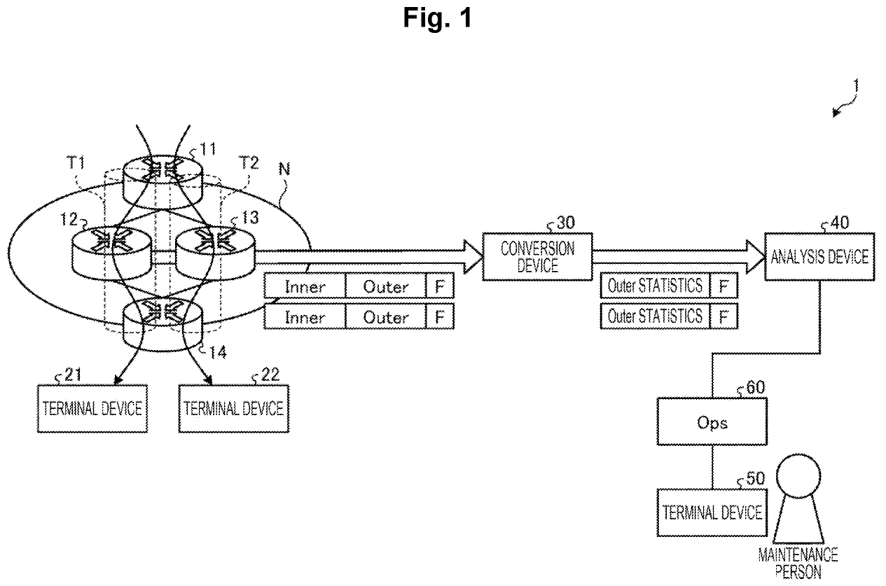

First, a configuration of a system according to a first embodiment will be described with reference to FIG. 1. FIG. 1 is a diagram illustrating a configuration example of an analysis system according to a first embodiment.

As illustrated in FIG. 1, the analysis system 1 analyzes traffic of a network N. The analysis system 1 includes a conversion device 30, an analysis device 40, and a terminal device 50.

The network N is, for example, a core network. A network device 11, a network device 12, a network device 13, and a network device 14 are disposed in the network N.

Each network device is, for example, a router or a switch. The number and arrangement of the network devices are not limited to the example of FIG. 1.

In addition, the network N accommodates a plurality of networks. For example, a network of a plurality of users is connected to the network device 14.

The terminal device 21 and the terminal device 22 are arranged in a network of a user (hereinafter, a user network). The terminal device 21 and the terminal device 22 may be disposed in different user networks, or may be disposed in the same user network.

Here, the terminal device 21 and the terminal device 22 perform communication via the network N using the VPN. At that time, a tunnel T1 and a tunnel T2 which are virtual communication paths are configured in the network N.

In addition, the above-described encapsulation packet is transmitted and received in the VPN.

For example, in the example in FIG. 1, the encapsulation packet arrives at the terminal device 21 through the tunnel T1. That is, the encapsulation packet destined for the terminal device 21 is transferred to the network device 11, the network device 13, the network device 14, and the terminal device 21 in this order.

For example, in the example in FIG. 1, the encapsulation packet arrives at the terminal device 22 through the tunnel T2. That is, the encapsulation packet destined for the terminal device 22 is transferred to the network device 11, the network device 12, the network device 14, and the terminal device 22 in this order.

The conversion device 30 acquires an xFlow packet from the network N. For example, the conversion device 30 acquires xFlow packets from the network device 12 constituting the tunnel T1 and the network device 13 constituting the tunnel T2.

Hereinafter, processing in a case where the conversion device 30 acquires an xFlow packet from the network device 12 will be described. It is assumed that the network device 13 can perform processing similar to that of the network device 12.

The network device 12 samples a packet that generates traffic in the network N. The packet to be sampled is assumed to be an encapsulation packet.

Then, the network device 12 extracts the outer header (a header of the outer packet) and the inner header (a header of the inner packet) of the sampled packet, and transfers the xFlow packet encapsulating each extracted header to the conversion device 30.

Note that encapsulation here means embedding data in a payload portion of the xFlow packet.

Further, the network device 12 transfers the xFlow packet encapsulating the statistical information on the sampled packet to the conversion device 30.

Here, the statistical information is calculated on the basis of the inner header or the outer header. For example, the statistical information is the number of packets for each flow (inner flow or outer flow) based on the inner header or the outer header, the communication data amount (example of unit: Mbps), and the like.

For example, the statistical information calculated based on the outer header is encapsulated in the xFlow packet together with the outer header.

As a result, the conversion device 30 can acquire an xFlow packet including the outer header and the inner header of the sampled packet and an xFlow packet including the statistical information.

The conversion device 30 converts a format of the acquired xFlow packet and transfers the xFlow packet obtained by the conversion to the analysis device 40.

Here, the conversion device 30 extracts the statistical information of the outer flow from the acquired xFlow, and transfers an xFlow packet encapsulating the extracted statistical information to the analysis device 40.

Here, in the tunnel T1 and the tunnel T2, each network device transfers the packet based on the outer header of the packet.

Therefore, the analysis device 40 specifies information regarding the VPN of the flow on the basis of the outer flow statistical information. For example, the analysis device 40 can specify the user of the VPN that is a source of the flow.

It is assumed that information (hereinafter, outer information) for specifying the VPN is registered in the analysis device 40 in advance. For example, a maintenance person registers the user of the VPN and the outer information in association with each other via an operation system (Ops) 60 using the terminal device 50.

The analysis device 40 collates the xFlow packet received from the conversion device 30 with the outer information to specify the VPN corresponding to the flow. Furthermore, the analysis device 40 can perform various analyses (for example, aggregation of statistical information) regarding traffic in addition to the identification of the VPN.

### Details of Conversion Device

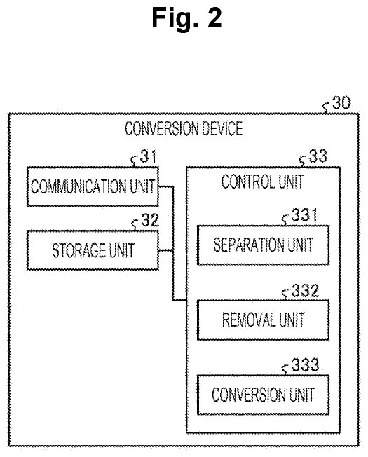

FIG. 2 is a diagram illustrating a configuration example of a conversion device according to the first embodiment. As illustrated in FIG. 2, the conversion device 30 includes a communication unit 31, a storage unit 32, and a control unit 33.

The communication unit 31 is an interface for transmitting and receiving data to and from other devices. For example, the communication unit 31 is a network interface card (NIC).

The storage unit 32 is a storage device such as a hard disk drive (HDD), a solid state drive (SSD), or an optical disc. The storage unit 32 may be a semiconductor memory capable of rewriting data, such as a random access memory (RAM), a flash memory, or a non volatile static random access memory (NVSRAM).

The storage unit 32 stores data related to an operating system (OS) and various programs executed by the conversion device 30.

The control unit 33 controls the entire conversion device 30. The control unit 33 includes, for example, an electronic circuit such as a central processing unit (CPU), a micro processing unit (MPU), or a graphics processing unit (GPU), or an integrated circuit such as an application specific integrated circuit (ASIC) or a field programmable gate array (FPGA).

In addition, the control unit 33 includes an internal memory for storing programs and control data defining various processing procedures, and executes each type of processing using the internal memory. Furthermore, the control unit 33 functions as various processing units by various programs operating.

For example, the control unit 33 functions as a separation unit 331, a removal unit 332, and a conversion unit 333.

The separation unit 331 separates the xFlow packet acquired by the conversion device 30 into an xFlow packet including an outer header and an inner header of the sampled packet and an xFlow packet including statistical information.

The removal unit 332 removes the outer header from the xFlow packet including the outer header and the inner header of the sampled packet among the xFlow packets separated by the separation unit 331.

Thus, the analysis device 40 can perform analysis using not only the outer header but also the inner header. However, the analysis target in the first embodiment is the outer header.

The conversion unit 333 generates an xFlow packet in a format according to processing content of an output destination (for example, the analysis device 40) of the conversion device 30 from the xFlow packet acquired by the conversion device 30.

The conversion unit 333 converts the format of the xFlow packet including the statistical information among the xFlow packets separated by the separation unit 331. The conversion unit 333 may output the xFlow packet including the statistical information without changing. Furthermore, the conversion unit 333 may calculate statistical information from the outer header and generate an xFlow packet including the calculated statistical information.

### Configuration of Analysis Device

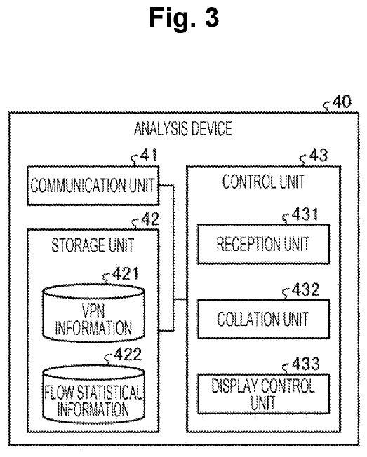

FIG. 3 is a diagram illustrating a configuration example of the analysis device according to the first embodiment. As illustrated in FIG. 3, the analysis device 40 includes a communication unit 41, a storage unit 42, and a control unit 43.

The communication unit 41 is an interface for transmitting and receiving data to and from other devices. For example, the communication unit 41 is an NIC.

The storage unit 42 is a storage device such as an HDD, an SSD, or an optical disk. Note that the storage unit 42 may be a data-rewritable semiconductor memory such as a RAM, a flash memory, or an NVSRAM.

The storage unit 42 stores data related to the OS and various programs executed by the analysis device 40.

For example, the storage unit 42 stores VPN information 421 and flow statistical information 422.

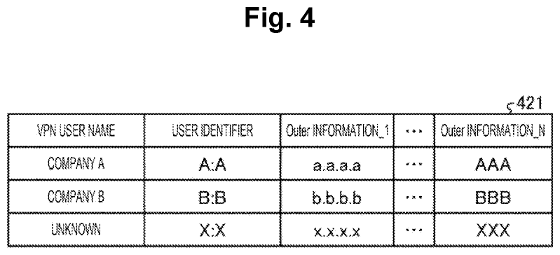

FIG. 4 is a diagram illustrating an example of VPN information. The VPN information 421 is information in which information regarding the VPN and outer information are associated with each other.

A VPN user name and a user identifier of the VPN information 421 are an example of information regarding the VPN. In addition, the VPN information 421 includes N pieces of outer information (outer information_1, . . . , and outer information_N).

The outer information may be 5-tuple. In that case, for example, outer information_1, outer information_2, outer information_3, outer information_4, and outer information 5 correspond to a source IP address, a source port number, a destination IP address, a destination port number, and a protocol, respectively.

The example of FIG. 4 illustrates that the outer information_1 of the VPN with the VPN user name “A company” and the user identifier “A: A” is “a.a.a.a” and the outer information_N is “AAA”. Note that an IP address including four octets is expressed as “a.a.a.a”.

For the VPN in which a correspondence between the user of the VPN and the outer information is known, for example, the VPN information is registered in advance by the maintenance person.

On the other hand, for the VPN in which the correspondence between the VPN user and the outer information is unknown, the VPN information is automatically registered by the analysis device 40 (corresponding to a record in which the VPN user name is “unknown”).

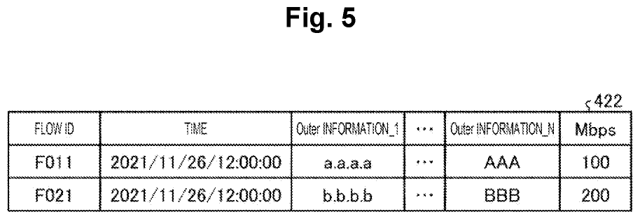

FIG. 5 is a diagram illustrating an example of flow statistical information. The flow statistical information 422 is statistical information extracted from the xFlow packet.

The flow statistical information 422 includes the outer information corresponding to the outer information of the VPN information 421.

The example of FIG. 5 illustrates that reception time of the flow with the flow ID “F011” is “2021 Nov. 26/12:00:00”, the outer information_1 is “a.a.a.a”, the outer information_N is “AAA”, and the Mbps is “100 Mbps”.

Note that Mbps is a communication data amount and is an example of the outer statistical information.

The control unit 43 controls the entire analysis device 40. The control unit 43 is, for example, an electronic circuit such as a CPU, an MPU, or a GPU, or an integrated circuit such as an ASIC or an FPGA.

In addition, the control unit 43 includes an internal memory for storing programs and control data defining various processing procedures, and executes each type of processing using the internal memory. Furthermore, the control unit 43 functions as various processing units by operating various programs.

For example, the control unit 43 functions as a reception unit 431, a collation unit 432, and a display control unit 433.

The reception unit 431 receives an xFlow packet that is generated on the basis of a sampled encapsulation packet and includes information regarding an outer header of the encapsulation packet and statistical information of a flow including the encapsulation packet.

The collation unit 432 collates the information regarding the outer header associated with the information for identifying the user of the VPN with the information regarding the outer header included in the xFlow packet received by the reception unit 431, and specifies the user of the VPN from which the xFlow packet is transferred. The collation unit 432 extracts the outer header (for example, 5-tuple) from the xFlow packet which is received by the reception unit 431 and includes the outer header and statistical information regarding the outer header.

Then, the collation unit 432 compares the extracted outer header with the outer information of the VPN information 421.

When the outer header matches the outer information of the VPN information 421, the collation unit 432 stores the outer header in the flow statistical information 422 together with the statistical information. Note that the outer header is stored as the outer information in the flow statistical information 422.

In a case where the information regarding the outer header associated with the information for identifying the user of the VPN and the information regarding the outer header included in the xFlow packet received by the reception unit 431 do not match, the collation unit 432 stores the information regarding the outer header included in the xFlow packet and the information indicating that the user of the VPN is unknown in the storage unit 42 in association with each other.

For example, when the outer header does not match the outer information of the VPN information 421 (when there is no matching header), the collation unit 432 adds the VPN user name “unknown” and the user identifier “X:X” to the outer header and adds the outer header to the VPN information 421.

The added information corresponds to information to which the record having the user name “unknown” in FIG. 4 is added in this case.

As a result of the collation by the collation unit 432, in a case where the information regarding the outer header associated with the information for identifying the user of the VPN and the information regarding the outer header included in the xFlow packet received by the reception unit 431 match, the display control unit 433 displays the statistical information included in the xFlow packet on the screen of the terminal device 50.

The terminal device 50 is a terminal device used by the maintenance person, and is, for example, a personal computer, a smartphone, or the like.

### Flow of Processing

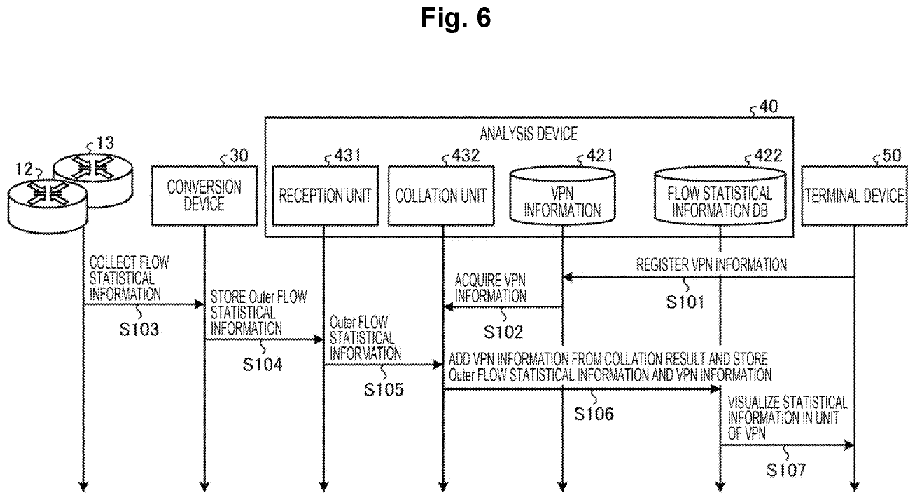

A flow of processing of the analysis system 1 will be described with reference to FIG. 6. FIG. 6 is a sequence diagram illustrating the flow of processing of the analysis system.

First, the terminal device 50 registers the VPN information 421 according to the operation of the maintenance person (step S101). The collation unit 432 acquires the VPN information 421 (step S102).

Next, the conversion device 30 collects flow statistical information from the network device 12 and the network device 13 (step S103).

Here, the conversion device 30 stores the outer flow statistical information in the reception unit 431 of the analysis device 40 (step S104). The outer flow statistical information is a communication data amount or the like calculated on the basis of the outer header.

The reception unit 431 passes the outer flow statistical information to the collation unit 432 (step S105).

The collation unit 432 collates the outer flow statistical information with the VPN information 421, and when the outer flow statistical information and the VPN information do not match, adds the VPN information 421 from a collation result and stores the outer flow statistical information and the VPN information in the storage unit 42 (step S106).

When the outer flow statistical information and the VPN information 421 match as a result of collation, the collation unit 432 adds the outer flow statistical information and the corresponding outer header to the flow statistical information 422.

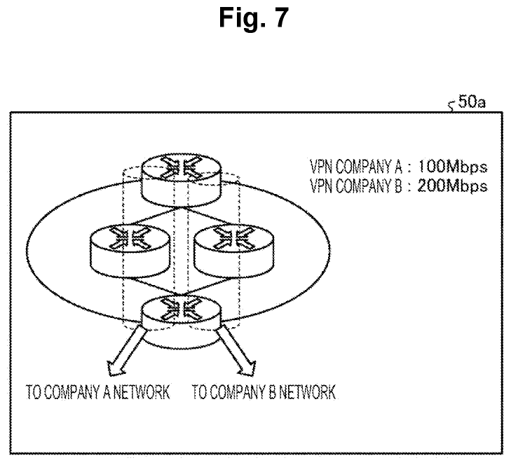

Further, the analysis device 40 visualizes the statistical information in units of VPNs (step S107). For example, the analysis device 40 displays an analysis result screen 50a as illustrated in FIG. 7 on the terminal device 50. FIG. 7 is a diagram illustrating an example of the analysis result screen.

As illustrated in FIG. 7, the analysis result screen 50a displays the configuration of the tunnel together with a schematic diagram of the network. In addition, the analysis result screen 50a shows a network to which each tunnel is connected.

Further, the analysis result screen 50a displays statistics for each VPN. The example of FIG. 7 illustrates that a communication data amount of “A company” which is a user of the VPN is “100 Mbps”.

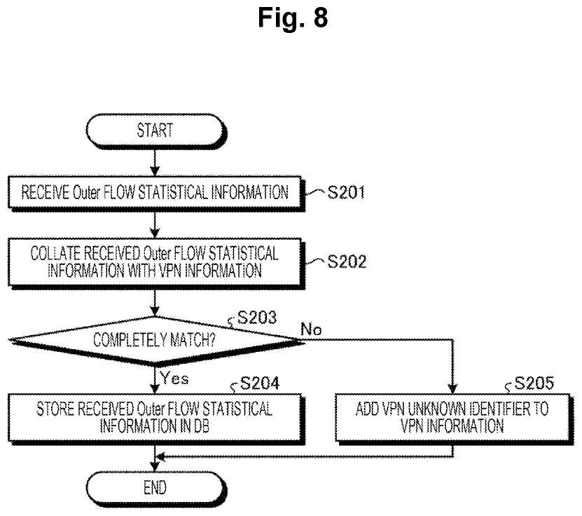

A flow of processing of the analysis device 40 will be described with reference to FIG. 8. FIG. 8 is a flowchart illustrating the flow of processing of the analysis device.

As illustrated in FIG. 8, first, the analysis device 40 receives the outer flow statistical information (step S201). Note that the outer flow statistical information is included in the xFlow packet output from the conversion device 30.

The analysis device 40 collates the received outer flow statistical information with the VPN information (step S202). At this time, the analysis device 40 compares the outer information of the VPN information 421 with the outer header corresponding to the outer statistical information.

When the outer header and the outer information completely match (step S203, Yes), the analysis device 40 stores the received outer flow statistical information in the DB (flow statistical information 422) (step S204).

On the other hand, when the outer header and the outer information do not completely match (step S203, No), the analysis device 40 adds the VPN unknown identifier to the VPN information 421 (step S205).

The record in which the VPN user name is “unknown” in FIG. 4 is an example of information added in step S205. “X:X” is an example of a VPN unknown identifier.

### Effects of First Embodiment

As described above, the reception unit 431 receives the xFlow packet generated on the basis of the sampled encapsulation packet and including the information regarding the outer header of the encapsulation packet and the statistical information of the flow including the encapsulation packet. The collation unit 432 collates the information regarding the outer header associated with the information for identifying the user of the VPN with the information regarding the outer header included in the xFlow packet received by the reception unit 431, and specifies the user of the VPN from which the xFlow packet is transferred.

As a result, the statistical information included in the xFlow packet can be classified for each VPN. As a result, according to the first embodiment, traffic can be analyzed in units of VPNs.

In a case where the information regarding the outer header associated with the information for identifying the user of the VPN and the information regarding the outer header included in the xFlow packet received by the reception unit 431 do not match, the collation unit 432 stores the information regarding the outer header included in the xFlow packet and the information indicating that the user of the VPN is unknown in association with each other in the storage unit 42.

As a result, information about VPNs that are not registered in advance can be held. For example, the added record having the user name of “unknown” can be used for correct and incorrect determination of the VPN information 421 or update of the VPN information 421.

As a result of the collation by the collation unit 432, in a case where the information regarding the outer header associated with the information for identifying the user of the VPN and the information regarding the outer header included in the xFlow packet received by the reception unit 431 match, the display control unit 433 displays the statistical information included in the xFlow packet on the screen of the terminal device 50.

As a result, the statistical information can be aggregated and analyzed for each VPN.

### System Configuration and Others

Moreover, each component of each illustrated device is functionally conceptual, and does not necessarily need to be physically configured as illustrated. That is, a specific form of distribution and integration of each device is not limited to the illustrated form, and all or some thereof can be functionally or physically distributed or integrated in any unit according to various loads, use status, and the like. Furthermore, all or any part of each processing function performed in each device can be realized by a central processing unit (CPU) and a program analyzed and executed by the CPU, or may be realized as hardware by wired logic. Note that the program may be executed not only by a CPU but also by another processor such as a GPU.

Further, among processing operations described in the present embodiment, all or some of processing operations described as being automatically performed can be manually performed, or all or some of processing operations described as being manually performed can be automatically performed by a known method. In addition, the processing procedure, the control procedure, the specific name, and the information including various data and parameters that are illustrated in the document and the drawings can be freely changed unless otherwise specified.

### Program

In an embodiment, the analysis device 40 can be implemented by installing an analysis program that executes the above-described analysis processing as packaged software or online software in a desired computer. For example, an information processing device is caused to execute the above-described analysis program, and thereby the information processing device can be caused to function as the analysis device 40. The information processing device mentioned here includes a desktop or a laptop personal computer. Moreover, the information processing device also includes a mobile communication terminal such as a smartphone, a mobile phone, and a personal handyphone system (PHS), a slate terminal such as a personal digital assistant (PDA), and the like.

In addition, in a case where a terminal device used by a user is implemented as a client, the analysis device 40 can be implemented as an analysis server device that provides a service regarding the above analysis processing for the client. For example, the analysis server device is implemented as a server device that provides an analysis service having an xFlow packet as an input and an analysis result as an output. In this case, the analysis server device may be implemented as a web server or may be implemented as a cloud that provides a service related to the above analysis processing by outsourcing.

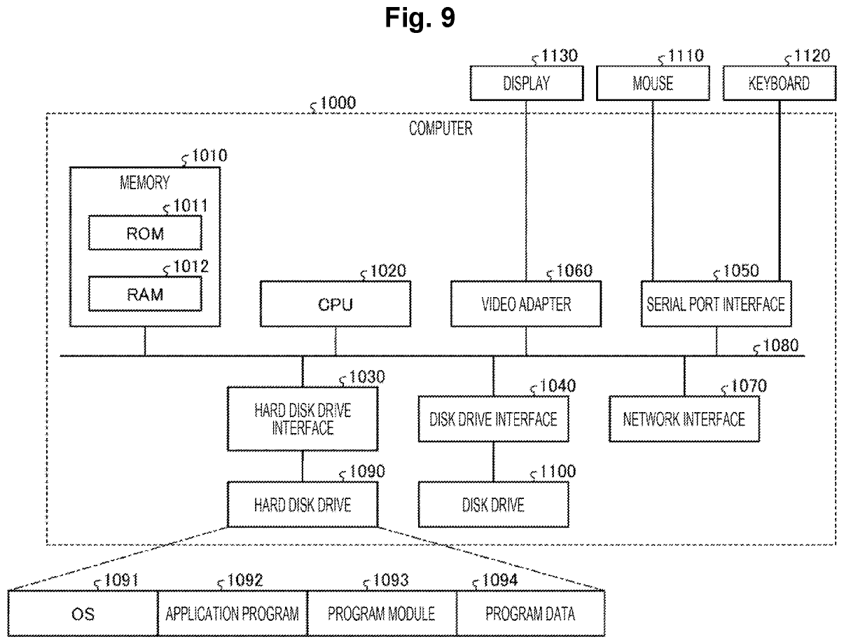

FIG. 9 is a diagram illustrating an example of a computer that executes the analysis program. A computer 1000 includes a memory 1010 and a CPU 1020, for example. The computer 1000 also includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to a mouse 1110 and a keyboard 1120, for example. The video adapter 1060 is connected to, for example, a display 1130.

The hard disk drive 1090 stores, for example, an OS 1091, an application program 1092, a program module 1093, and program data 1094. That is, a program that defines each processing operation of the analysis device 40 is implemented as the program module 1093 in which a code executable by a computer is described. The program module 1093 is stored in, for example, the hard disk drive 1090. For example, the program module 1093 for executing processing similar to the functional configuration in the analysis device 40 is stored in the hard disk drive 1090. Note that the hard disk drive 1090 may be replaced with a solid state drive (SSD).

In addition, setting data used in the processing of the above-described embodiment is stored, for example, in the memory 1010 or the hard disk drive 1090 as the program data 1094. Then, the CPU 1020 reads the program module 1093 and the program data 1094 stored in the memory 1010 and the hard disk drive 1090 to the RAM 1012 as necessary, and executes the processing of the above-described embodiment.

Note that the program module 1093 and the program data 1094 are not limited to being stored in the hard disk drive 1090, and may be stored in, for example, a detachable storage medium and read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from another computer via the network interface 1070.

### REFERENCE SIGNS LIST

N Network
T1, T2 Tunnel
11, 12, 13, 14 Network device
21, 22, 50 Terminal device
30 Conversion device
40 Analysis device
60 Ops
31, 41 Communication unit
32, 42 Storage unit
33, 43 Control unit
50a Analysis result screen
331 Separation unit
332 Removal unit
333 Conversion unit
421 VPN information
422 Flow statistical information
431 Reception unit
432 Collation unit
433 Display control unit

1. An analysis device comprising:
a reception unit configured to receive an xFlow packet generated based on a sampled encapsulation packet, the xFlow packet including information regarding an outer header of the encapsulation packet and statistical information of a flow including the encapsulation packet; and
a collation unit configured to collate information regarding an outer header associated with information for identifying a user of a VPN and information regarding an outer header included in an xFlow packet received by the reception unit to specify the user of the VPN from which the xFlow packet is transferred.

2. The analysis device according to claim 1, wherein in a case where the information regarding the outer header with which the information for identifying the user of the VPN is associated and the information regarding the outer header included in the xFlow packet received by the reception unit do not match, the collation unit stores the information regarding the outer header included in the xFlow packet and the information indicating that the user of the VPN is unknown in association with each other in a storage unit.

3. The analysis device according to claim 1, further comprising:
a display control unit configured to display the statistical information included in the xFlow packet on a screen of a terminal device in a case where information regarding an outer header associated with information for identifying a user of a VPN and information regarding an outer header included in the xFlow packet received by the reception unit match as a result of the collating by the collation unit.

4. An analysis method comprising:
a receiving step of receiving an xFlow packet generated based on a sampled encapsulation packet, the xFlow packet including information regarding an outer header of the encapsulation packet and statistical information of a flow including the encapsulation packet;
a collating step of collating information regarding an outer header associated with information for identifying a user of a VPN and information regarding an outer header included in an xFlow packet received in the receiving step to specify a user of the VPN from which the xFlow packet is transferred.

5. (canceled)

6. The analysis method according to claim 4, wherein in a case where the information regarding the outer header with which the information for identifying the user of the VPN is associated and the information regarding the outer header included in the xFlow packet received do not match, the information regarding the outer header included in the xFlow packet and the information indicating that the user of the VPN is unknown in association with each other.

7. The analysis method according to claim 4, further comprising:
displaying the statistical information included in the xFlow packet on a screen of a terminal device in a case where information regarding an outer header associated with information for identifying a user of a VPN and information regarding an outer header included in the xFlow packet received match as a result of the collating.

8. A computer-readable non-transitory recording medium storing computer-executable program instructions that when executed by a processor cause a computer to execute an analysis method comprising:
receiving an xFlow packet generated based on a sampled encapsulation packet, the xFlow packet including information regarding an outer header of the encapsulation packet and statistical information of a flow including the encapsulation packet; and
collating information regarding an outer header associated with information for identifying a user of a VPN and information regarding an outer header included in an xFlow packet received in the receiving step to specify a user of the VPN from which the xFlow packet is transferred.

9. The analysis method according to claim 8, wherein in a case where the information regarding the outer header with which the information for identifying the user of the VPN is associated and the information regarding the outer header included in the xFlow packet received do not match, the information regarding the outer header included in the xFlow packet and the information indicating that the user of the VPN is unknown in association with each other.

10. The analysis method according to claim 8, further comprising:
displaying the statistical information included in the xFlow packet on a screen of a terminal device in a case where information regarding an outer header associated with information for identifying a user of a VPN and information regarding an outer header included in the xFlow packet received match as a result of the collating.

11. The analysis device according to claim 1, further comprising:
a separating unit configured to separate the xFlow packet acquired by a conversion device into xFlow packets containing the outer header and inner headers of the sampled encapsulation packes and the xFlow packet containing statistical information.

12. The analysis device according to claim 11, further comprising:
a removal unit configured to remove the outer header from the xFlow packet containing the outer header and inner header of the sampled packet among the xFlow packet separated by the separation unit.

13. The analysis device according to claim 11, further comprising:
a conversion unit configured to convert the xFlow packet acquired by the conversion device into an xFlow packet in a format corresponding to the processing content of the output destination.

14. The analysis method according to claim 4, further comprising:
a separation step of separating the xFlow packet acquired into xFlow packets containing the outer header and inner headers of the sampled encapsulation packes and the xFlow packet containing statistical information.

15. The analysis method according to claim 14, further comprising:
a removal step of removing the outer header from the xFlow packet containing the outer header and inner header of the sampled packet among the xFlow packet separated.

16. The analysis method according to claim 15, further comprising:
a conversion step of converting the xFlow packet acquired into an xFlow packet in a format corresponding to the processing content of the output destination.

17. The analysis method according to claim 8, further comprising:
separating the xFlow packet acquired into xFlow packets containing the outer header and inner headers of the sampled encapsulation packes and the xFlow packet containing statistical information.

18. The analysis method according to claim 17, further comprising:
removing the outer header from the xFlow packet containing the outer header and inner header of the sampled packet among the xFlow packet separated.

19. The analysis method according to claim 18, further comprising:
converting the xFlow packet acquired into an xFlow packet in a format corresponding to the processing content of the output destination.

20. The analysis method according to claim 8, further comprising:
matching the information on the outer header associated with the information identifying a VPN user with the information on the outer header included in the xFlow packet received and transfer the xFlow packet.

21. The analysis device according to claim 1, wherein a matching unit extracts the outer header from the xFlow packet received by a receiving unit and containing the outer header and statistical information about the outer header.
